(19) United States
(12) Patent Application Publication
(10) Pub. No.: US 2010/0264563 A1
(43) Pub. Date: Oct. 21, 2010

(54) ENCAPSULATION METHOD AND ENCAPSULATION APPARATUS FOR A FIELD CIRCUIT PROVIDED WITHIN A ROTOR BODY

(75) Inventors: Ralf Cordes, Erlangen (DE); Walter Fischer, Muhldorf am Inn (DE); Jürgen Huber, Erlangen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, 80333 Munchen (DE)

(21) Appl. No.: 12/667,596

(22) PCT Filed: Jul. 1, 2008
(86) PCT No.: PCT/EP08/58440

§ 371 Date: May 4, 2010

(30) Foreign Application Priority Data
Jul. 4, 2007 (DE) 10 2007 030 963.7

(51) Int. Cl. B29C 45/14; B28B 17/00

(52) U.S. Cl. 264/272.14; 425/506

(57) ABSTRACT

The invention relates to a potting method and a device (100) for potting an excitation circuit that is arranged inside a rotor body. Said excitation circuit has a circuit board (102, 103) having contacts (103, 103′) on the edge of said circuit board (102, 103), the contacts (103, 103′) being arranged in a tolerance zone (109) around a cylindrical peripheral surface (110) that is concentric to the rotor body. The excitation circuit is located inside a potting zone (101) which is sealed in a liquid-tight manner by a toroidal elastic ring (111) in such a manner that surfaces of the contacts (103, 103′) lying within the tolerance zone (109) are at the same time in contact with the toroidal elastic ring (112).

The invention relates to an encapsulation method and encapsulation apparatus for a field circuit which is provided within a rotor body.

Electrical machines have field windings as part of their rotor. Superconducting machines have field windings which are manufactured from a superconducting material. In particular, superconducting machines may have field windings which are manufactured from high-temperature superconductor material.

A field circuit for excitation of the windings of an electrical machine is typically arranged within the rotor of the electrical machine. A field circuit such as this has, inter alia, an alternating-current transformer and a rectifier. One such field circuit is disclosed, for example, in DE 10 2005 047 541 A1.

A field circuit which is arranged within the rotor of an electrical machine is subject to considerable mechanical loads during operation of the electrical machine. The synchronous rotation speed of a two-pole synchronous machine at a mains frequency of 60 Hz is 3600 rpm. With the typical housing sizes of machines such as these, centripetal accelerations of several 1000 g occur, caused by the rotation of the rotor, and act on the field circuit which is arranged within the rotor. Furthermore, the field circuit which is arranged within the rotor is subject to vibration occurring in the rotor. In addition, dust (in some cases electrically conductive dust), moisture, extreme temperatures, etc. occur in the area of the rotor during operation of an electrical machine, and can damage the field circuit. In some cases, a field circuit has complex circuits which, in particular, may have power-electronic components such as IGBTs, MOSFETs, thyristors, power diodes etc. Power-electronic components such as these cause considerable amounts of heat loss during operation, which must be dissipated from the area of the field circuit.

The object of the present invention is to specify an encapsulation method and an encapsulation apparatus for a field circuit which is arranged within a rotor body. The encapsulation method according to the invention and the encapsulation apparatus according to the invention are intended to be improved with respect to the technical problems that exist with the prior art. One particular aim is to specify an encapsulation method for a field circuit which allows mechanically robust encapsulation of the field circuit within the rotor body, with the aim at the same time of ensuring good thermal coupling between the field circuit and the rotor body. A further aim, in particular, is to specify an encapsulation apparatus for a method such as this.

With regard to the method, the object is achieved by the measures specified in claim 1. An encapsulation method is accordingly specified for a field circuit which is arranged within an encapsulation area in the interior of a rotor body. The encapsulation area is bounded at the radially outer edge by the inside of a casing of the rotor body, or components which are thermally coupled directly to the casing of the rotor body. Furthermore, the encapsulation area is bounded on both sides in the axial direction by a cover plate, which is oriented essentially at right angles to an axis of the rotor body, and by a bottom plate. The field circuit comprises at least one board, with electrical components provided on the board, and contacts arranged at the edge of the board. The encapsulation method according to the invention has at least the following steps:

Locking of the field circuit in the encapsulation area such that the contacts are arranged in a tolerance area around a cylindrical casing surface, wherein the cylindrical casing surface is oriented coaxially with respect to the rotor body.

Interlocking pressing of a toroidal elastic ring onto those contact surfaces of the contacts whose surface normals are oriented essentially in the direction of the axis. Furthermore, interlocking pressing of the toroidal elastic ring at least onto the bottom plate for liquid-tight closure of the encapsulation area. The toroidal elastic ring is in this case pressed against the bottom plate and the contact surfaces of the contacts such that all of the contact surfaces which are located in the tolerance area are at least partially in contact with the toroidal elastic ring.

Encapsulation of the encapsulation area with an encapsulation compound.

In particular, the measures according to the invention are linked to the following advantages. The abovementioned measures allow simple encapsulation, without any cavities, of a field circuit in the interior of a rotor body. This advantageously makes it possible to mechanically hold the field circuit well within the rotor body. Furthermore, the abovementioned measures according to the invention allow good thermal coupling of the field circuit to the encapsulation compound. In particular, the electrical components of the field circuit can be coupled to the encapsulation compound. The arrangement of the encapsulation area in the edge area of the rotor advantageously also allows good thermal coupling of the encapsulation compound, and therefore, of the electrical components of the field circuit, to the rotor casing.

Advantageous refinements of the encapsulation method according to the invention are specified in the claims which are dependent on claim 1. In this case, the encapsulation method as claimed in claim 1, can be combined in particular with the features of one or else more dependent claims. The encapsulation method may accordingly also have the following features:
Before the encapsulation of the encapsulation area, a displacement body can be introduced into the encapsulation area. Introduction of a displacement body into the encapsulation area makes it possible to save encapsulation compound. A displacement body also makes it possible to reduce the encapsulation volume. A reduced encapsulation volume and therefore a reduced amount of encapsulation compound lead to a reduction in the mechanical stresses which occur in the encapsulation area between the encapsulation compound and components of the field circuit. The different materials which are used in a field circuit typically have different material characteristic values, for example coefficients of expansion. It is virtually impossible to match the coefficients of expansion of the encapsulation compound to all the materials that are present in the field circuit, and to their coefficients of expansion. Since the expansion response is proportional to the mass of the relevant material, it is advantageous to save encapsulation compound by means of a displacement body, and thus to minimize the forces which act on the components of the field circuit from the encapsulation compound as a result of thermal expansion.
Before introduction into the encapsulation area, the displacement body can be matched to a shape of the board and to a shape of the electrical components which are provided on the board. Matching the shape of the displacement body to the shape of the board and to the shape of the components which are provided on the board allows further encapsulation compound to be saved, leading to further cost advantages.
The encapsulation area can be heated in order to cure the encapsulation compound. Thermal curing of the encapsulation compound offers the process advantage that the process is carried out quickly, and this is therefore particularly advantageous for encapsulation of circuits in a rotor.
The step of encapsulation can be carried out using a method from the following group:
   atmospheric encapsulation methods,
   vacuum encapsulation methods,
   pressure gelling methods,
   injection-molding methods,
   hot-melt methods.

The abovementioned methods are particularly advantageous for encapsulation of field circuits in rotors.
The encapsulation of the field circuit within the encapsulation area in the interior of a rotor body can be carried out using a hybrid system comprising an encapsulation compound and an adhesive compound. In particular, the encapsulation can be carried out using a reaction resin system based on one material or a plurality of materials, which can be selected from the following group:
   epoxy resin,
   polyurethane,
   silicone,
   polyester resin,
   polyimide resin, or
   hydrocarbon resin.
The encapsulation of a field circuit using a reaction resin system composed of encapsulation compound and adhesive compound, in particular based on one of the abovementioned materials, is particularly advantageous since mechanical stresses can be absorbed in a system such as this. Mechanical stresses may be the consequence of alternating thermal loads, such as those which can occur in rotors. Encapsulation using a reaction resin system furthermore has high mechanical strength. Centripetal accelerations which occur in a rotor, and the forces which result from them, can likewise be absorbed by a corresponding system.
The encapsulation compound may have at least one material from the following material group added to it. The material group comprises, fillers, fibers, fabrics, hollow glass balls, flakes and agglomerations. The addition of a material from the abovementioned material group to the encapsulation compound makes it possible to improve the mechanical strength of the encapsulation compound. In particular, it is possible to improve the capability of the encapsulation compound to withstand centripetal accelerations.

With regard to the apparatus, the object is achieved by the measures specified in claim 9.

An encapsulation apparatus is accordingly specified for a field circuit which is arranged within an encapsulation area in the interior of a rotor body. The encapsulation area is bounded at the radially outer edge by the inner face of a casing of the rotor body or components which are thermally connected directly to the casing of the rotor body. Furthermore, the encapsulation area is bounded in the axial direction on both sides by a cover plate, which is oriented essentially at right angles to the axis of the rotor body, and by a bottom plate. The field circuit comprises at least one board with electrical components which are provided on the board. Contacts which can be used to make contact with the field circuit are arranged at the edge of the board. The encapsulation apparatus furthermore comprises:

A holder for locking the field circuit in the encapsulation area, by means of which the field circuit can be locked in the encapsulation area such that the contacts are arranged in a tolerance area around a cylindrical casing surface. The cylindrical casing surface is oriented coaxially with respect to the rotor body. The encapsulation apparatus furthermore has a toroidal elastic ring which is pressed onto those contact surfaces of the contacts whose surface normal is oriented essentially in the direction of the axis. Furthermore, the toroidal elastic ring is pressed at least onto the bottom plate for liquid-tight closure of the encapsulation area. The toroidal elastic ring is also pressed on such that all of the contact surfaces which are located in the tolerance area are at least partially in contact with the toroidal elastic ring.

Advantageous refinements of the encapsulation apparatus according to the invention are specified in the claims which are dependent on claim 9. In this case the encapsulation apparatus according to the invention can be combined with the features of a dependent claim, and in particular with the features of a plurality of dependent claims. The encapsulation apparatus can accordingly also have the following features:
The holder for the electrical components of the field circuit may extend in the circumferential direction of the rotor body, on its inner face. On its radially inner face, the holder may have recesses or flattened areas for interlocking accommodation of the electrical components. On its radially outer face, the holder can be matched to the shape of the inner wall of the rotor body. A holder which has the features described above can advantageously be used to hold the electronic components of a field circuit in a mechanically robust form in the interior of the rotor body.
The electronic components may be power semiconductors. It is particularly advantageous for the power semiconductors of a field circuit to be held in a mechanically robust manner.
The electrical components may have heat transfer surfaces, and the heat transfer surfaces can make thermal contact over a large area with the recesses or flattened areas. The recesses or flattened areas can be aligned such that their surface normals point essentially in the radial direction. A holder for the electrical components of a field circuit which is in contact over a large area with the heat transfer surfaces of the electrical components, wherein the surface normals of these heat transfer surfaces also point essentially in a radial direction, ensures on the one hand good thermal coupling of the electrical components to the holder, and on the other hand that the electrical components are mechanically held well, in particular with regard to the absorption of centrifugal forces.
The electrical components can be screwed to the holder. Alternatively, the electrical components can be connected to the holder by brackets. Use of a screw connection or brackets to hold the electrical components on the holder allows simple and rapid assembly.
The holder may be composed of highly thermally conductive material, preferably of copper. A highly thermally conductive material, in particular copper, allows good thermal coupling of the electrical components to the holder, and therefore to the rotor body. This advantageously allows the heat losses created in the electrical components to be dissipated to the rotor body.
The holder can be integrally connected to the inner face of the rotor in the circumferential direction of the rotor. On its radially inner face, the holder may have recesses with wall surfaces and bottom surfaces for interlocking accommodation of the electrical components of the field circuit. The surface normals to the bottom surfaces may point in the direction of the axis. A holder as described above allows the electrical components of a field circuit to be accommodated in a mechanically particularly robust manner.
The holder may be composed predominantly of a fiber-reinforced plastic, in particular of a glass-fiber-reinforced, carbon-fiber-reinforced or aramid-fiber-reinforced plastic. Furthermore, the holder may be composed of a foam or may have a sandwich structure. The abovementioned materials have high strength with low weight, which is particularly advantageous for holding electronic components of a field circuit within a rotor.
The toroidal elastic ring may be composed predominantly of silicone. If the toroidal elastic ring is formed from silicone, this offers the advantage that it is elastic and can also prevent adhesion of the encapsulation compound to the toroidal elastic ring.
The contacts made be composed of copper. Copper offers good electrical and thermal conductivity, and allows electrically secure contacts to be made in this manner.
The encapsulation apparatus may comprise at last one displacement body which is matched to the shape of the board or boards, and in particular to the shape of the electrical components which are provided on the board or boards. Furthermore, this displacement body may be composed predominantly of glass-fiber-reinforced plastic. A displacement body offers the advantage that encapsulation compound can be saved. A displacement body which is composed predominantly of glass-fiber-reinforced plastic furthermore offers the capability to considerably reduce weight.

Further advantageous refinements of the encapsulation method according to the invention and of the encapsulation apparatus according to the invention will become evident from the claims which have not been mentioned above, and in particular from the drawing, which will be explained in the following text. The drawing schematically illustrates exemplary embodiments of the encapsulation apparatus according to the invention, and of the encapsulation method according to the invention.

In this case, in the figures:

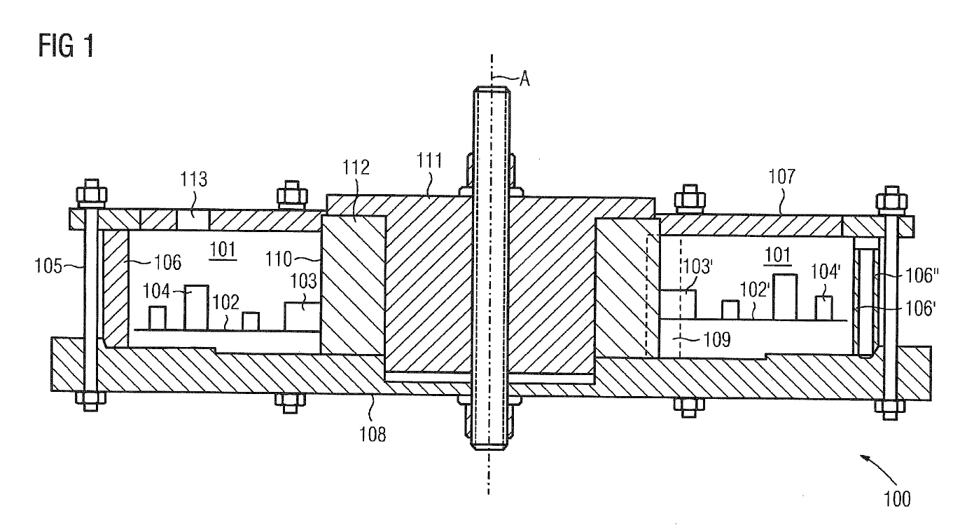

FIG. 1 shows a cross-sectional view of an encapsulation apparatus for a field circuit in the interior of a rotor body,

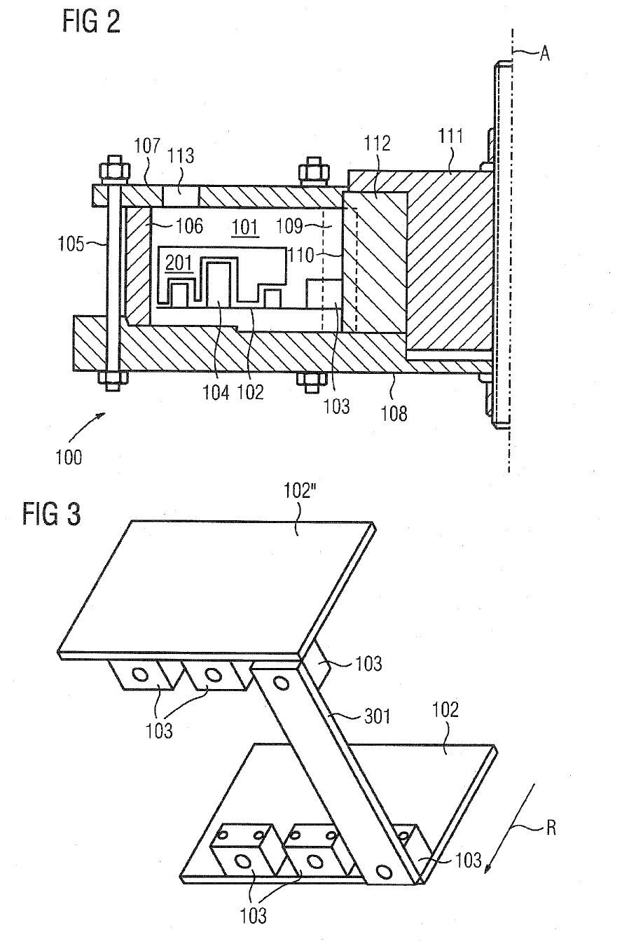

FIG. 2 shows a detailed view of an encapsulation apparatus,

FIG. 3 shows two boards of a field circuit, in the form of a perspective view, and

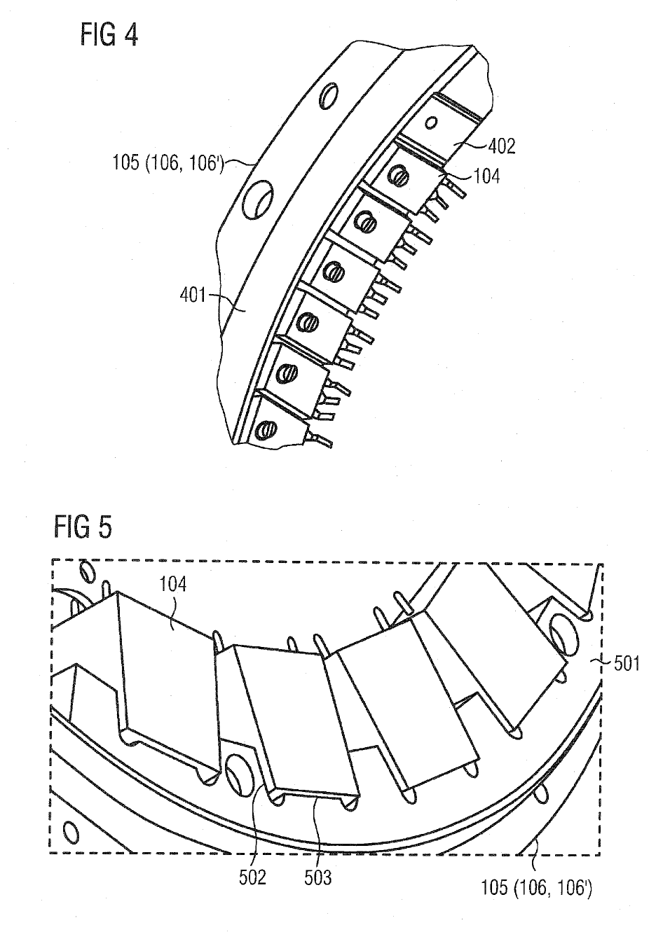

FIGS. 4 and 5 show a holder for the electrical components of a field circuit.

Corresponding parts in the figures are provided with the same reference symbols. Parts which are not referred to in any more detail are generally known prior art.

FIG. 1 shows an encapsulation apparatus 100 for a field circuit which is arranged within an encapsulation area 101 in the interior of a rotor body. In particular, the rotor body may be essentially rotationally symmetrical with respect to an axis A. The encapsulation area 101 extends in the circumferential direction in the edge area of the rotor body. The field circuit comprises at least one board 102, preferably a plurality of boards 102, 102′ and furthermore preferably further electrical components 104, which are not arranged on the board or boards. By way of example, the following text is based on the assumption of a situation in which the field circuit comprises only one board.

Contacts 103 which are arranged at the edge of the board 102 are located on the board 102. The contacts 103 are arranged on the side of the board 102 which points in the direction of the axis A. Furthermore, the field circuit comprises electrical components 104 which are arranged on the board 102. The electrical components 104 can preferably be power-electronic components, such as IGBTs, MOSFETs, thyristors, power diodes, etc.

The rotor body, which has a cover plate 107 and a bottom plate 108, is held by means of clamping screws 105. The encapsulation area 101 is bounded on its radially outer edge by the casing of the rotor body and further components of the rotor 106, 106′, 106″ which are thermally directly connected to the casing of the rotor body.

The board 102 can be locked within the encapsulation area 101 by generally technically conventional measures. Furthermore, the board 102 or else individual electrical components 104 of the field circuit can be locked by a special holder. The board 102 is locked within the encapsulation area 101 such that the contacts 103 are located in a tolerance area 109, which extends around a cylindrical casing surface 110. The cylindrical casing surface 110 is arranged essentially coaxially with respect to the rotor body, and therefore essentially coaxially with respect to the axis A. A tolerance area 109 extends along the circumference of the cylindrical casing surface 110, in the radial direction on both sides of the cylindrical casing surface 110. The tolerance area 109 may, in particular, have a predetermined radial width.

Before the insertion of a mandrel 111 into the encapsulation apparatus 100, a toroidal elastic ring 112 is introduced into the encapsulation apparatus 100 from the inside. The mandrel 111 may be cylindrical or else conical. The toroidal elastic ring 112 can preferably have an essentially rectangular cross section. Furthermore, the toroidal elastic ring 112 is inserted into the encapsulation apparatus 100 such that the toroidal elastic ring 112 is pressed by means of the mandrel 111 onto the cover plate 107 and the bottom plate 108 such that the encapsulation area 101 is closed in a liquid-tight manner. Alternatively, the toroidal elastic ring 112 can be inserted into the encapsulation apparatus 100 such that it closes the encapsulation area 101 in a liquid-tight manner on the contact surface between the bottom plate 108 and the toroidal elastic ring 112. In this case, the cover plate 107 can be placed on the rotor body after encapsulation has been carried out, and the actual encapsulation process is carried out as a so-called open encapsulation process. Furthermore, the toroidal elastic ring 112 is pressed in by means of the mandrel 111 such that those contact surfaces of the contacts 103 whose surface normal points in the direction of the axis A and which are located within the tolerance area 109 make contact with the toroidal elastic ring 112. Pressing the toroidal elastic ring 112 onto the contact surfaces in this way makes it possible to avoid those surfaces of the contacts 103 whose surface normals point in the direction of the axis A from being wetted with the encapsulation compound when the encapsulation compound is subsequently introduced into the encapsulation area 101. The contact surfaces of the contacts 103 are therefore free of encapsulation compound after encapsulation of the field circuit, and contact can therefore easily be made with them.

Encapsulation compound can be introduced into the encapsulation area 101 through an opening 113 in the cover plate 107 of the encapsulation apparatus 100. In order to ensure that the field circuit, in particular the board 102 and the electrical components 104 which are provided on the board, is encapsulated without any cavities, the board 102 and further electrical components 104 are arranged in the encapsulation area 101 such that the encapsulation compound can wet all the exposed surfaces of the board 102 and of the electrical components 104. In particular, the board 102 may have apertures or holes for this purpose, or may be arranged in the encapsulation area 101 such that corresponding gaps are provided for the encapsulation compound to pass through.

The edges of the components to be encapsulated may be inclined, chamfered or rounded. Further rotor parts which project into the encapsulation area 101 may likewise be inclined, chamfered or rounded. This makes it possible to avoid increased stresses in these areas during curing of the encapsulation compound.

FIG. 2 shows a view of part of an encapsulation apparatus 100. The encapsulation apparatus corresponds essentially to the left-hand part, as seen from the axis A, of the encapsulation apparatus 100 illustrated in FIG. 1. In addition to the encapsulation apparatus 100 illustrated in FIG. 1, the encapsulation apparatus 100 illustrated in FIG. 2 has a displacement body 201 which is arranged within the encapsulation area 101.

The displacement body 201 may, in particular, be manufactured from glass-fiber-reinforced plastic. The displacement body 201 may also, in particular, be matched to the shape of the board 102. Furthermore, the displacement body 201 may be matched to the components 104 which are provided on the board 102, and may be matched to the contacts 103. The displacement body 201 can likewise be matched to further electrical components 103 of the field circuit which are not mounted on the board 102. The displacement body 201 may be matched by shaping or else by 3D scanning. Encapsulation compound can be saved by means of the displacement body 201. Furthermore, the displacement body 201 may have a similar or virtually the same coefficient of expansion to that of the encapsulation compound. This makes it possible to reduce stress cracks or wall separation occurring as a result of temperature changes.

FIG. 3 shows two boards 102, 102″ of a field circuit, in the form of a perspective view. For clarity reasons, the figure does not show the components which are provided on the boards 102, 102″. The boards 102, 102″ are arranged essentially plane-parallel with respect to one another. The direction R shown in FIG. 3 points in the direction of the axis A.

During encapsulation of the boards 102, 102″, the contact surfaces of the contacts 103 whose surface normal points in the direction R are still free of encapsulation compound after the encapsulation process. The contact surfaces are therefore accessible from the inside of the rotor body and, may for example, make contact with a contact bar 301, which can preferably be manufactured from copper.

FIG. 4 shows a holder 401 for the electrical components 104 of a field circuit. On its radially outer face, that is to say that face which faces the rotor body 105, the holder 401 is matched to the shape of the rotor body 105. The holder 401 can likewise be connected essentially in an interlocking manner to parts 106, 106′ which are directly connected to the rotor body 105. The components 106, 106′ which are directly connected to the rotor body 105 may, in particular, be thermally connected to the rotor body. On its radially inner face, the holder 401 has flattened areas 402 or recesses for accommodation of electrical components 104. The electrical components 104 may, in particular, be power semiconductors such as IGBTs, MOSFETs, thyristors, power diodes, etc. The electrical components 104 may have heat transfer surfaces, by means of which they are connected over a large area to the holder 401. In particular, the heat transfer surfaces on the electrical component 104 may be connected over a large area to the flattened areas or recesses 402. In order to connect the electrical components 104 to the holder 401, the electrical components 104 may be screwed to the holder 401, or may be connected to the holder 401 by brackets. In particular, the holder 401 can be manufactured from a highly thermally conductive material, and the holder 401 is preferably manufactured from copper.

The surface normals to the flattened areas or recesses 402 may in particular point in the direction of the axis of the rotor body. Centripetal accelerations acting on the electrical components 104 can thus be absorbed over a large area by the holder.

The flattened areas or recesses 402 may also in particular be designed such that they accommodate the electrical components 104 in an interlocking manner.

FIG. 5 shows a further holder 401 for accommodation of electrical components 104 of a field circuit. The electrical components 104 may, in particular, be capacitors. The radially outer face of the holder 501 is matched in an interlocking manner to the rotor body 105. Furthermore, the holder 501 may be matched in an interlocking manner to components 106, 106′ which are directly connected to the rotor body 105. On its radially inner face, the holder 501 has recesses with wall surfaces and bottom surfaces (502, 503) for interlocking accommodation of the electrical components 104. The bottom surfaces (503) of the recesses may in this case be oriented such that their surface normals point in the direction of the axis of the rotor 105. In particular, the holder 501 may be manufactured from a glass-fiber-reinforced plastic.

The toroidal elastic ring 112 may, in particular, be manufactured from silicone or a silicone-like material.

The field circuit which is arranged within the rotor may be encapsulated by means of an apparatus according to one exemplary embodiment of the drawings as explained above. The encapsulation method according to the invention may in this case be developed in accordance with the following explanatory notes.

The encapsulation area may be heated by suitable measures in order to cure the encapsulation compound. Furthermore, an atmospheric encapsulation method, a vacuum encapsulation method, a pressure-gelling method, an injection-molding method or a hot-melt method may be used as encapsulation methods. Furthermore, a hybrid system comprising an encapsulation compound and an adhesive compound may be used as a material system for encapsulation. In particular, the encapsulation process can be carried out using a reaction resin system based on one or more of the following materials: epoxy resins, polyurethane, silicone, polyester resin, polyester imide resin and/or hydrocarbon resin. In order to reinforce the encapsulation compound, fillers, fibers, hollow glass balls, flakes, fabrics and/or agglomerations may be added to it.

1.-21. (canceled)

22. An encapsulation method for encapsulating a field circuit arranged within an interior of a rotor body and having at least one board with electrical components and contacts arranged along an edge of the board, the method comprising the steps of:
defining an encapsulation area having a radial direction and an axial direction, wherein an outer edge of the encapsulation area in the radial direction is bounded by an inside of a casing of the rotor body or components directly thermally coupled to the casing of the rotor body, and wherein the encapsulation area is bounded in the axial direction by a cover plate and a bottom plate which are oriented essentially perpendicular to an axis of the rotor body,
securing the field circuit in the encapsulation area such that the contacts are arranged in a tolerance area around a cylindrical casing surface oriented coaxially with respect to the rotor body,
pressing a toroidal elastic ring with a positive fit against contact surfaces of the contacts having a surface normal oriented substantially parallel to the axis of the rotor body and against at least the bottom plate for liquid-tight closure of the encapsulation area, such all contact surfaces located in the tolerance area are at least partially in contact with the toroidal elastic ring, and
encapsulating the encapsulation area with an encapsulation compound.

23. The method of claim 22, further comprising the step of introducing a displacement body into the encapsulation area before encapsulating the encapsulation area with the encapsulation compound.

24. The method of claim 23, further comprising the steps of matching the displacement body to a shape of the board and to a shape of the electrical components provided on the board, before introducing the displacement body into the encapsulation area.

25. The method of claim 22, further comprising the step of heating the encapsulation area in order to cure the encapsulation compound.

26. The method of claim 22, wherein the step of encapsulating comprises at least one process selected from the group consisting of atmospheric encapsulation, vacuum encapsulation, pressure gelling, injection-molding, and hot-melting.

27. The method of claim 22, wherein the step of encapsulating uses an adhesive compound in addition to an encapsulation compound.

28. The method of claim 27, wherein the step of encapsulating uses a reaction-resin-based encapsulation compound system comprising at least one material selected from the group consisting of epoxy resin, polyurethane, silicone, polyester resin, polyester imide resin, and hydrocarbon resin.

29. The method of claim 22, and further comprising the step of adding to the encapsulation compound at least one additional material selected from the group consisting of fillers, fibers, fabrics, agglomerations, hollow glass balls, and flakes.

30. An encapsulation apparatus for encapsulating a field circuit disposed in an encapsulation area in an interior of a rotor body, wherein the encapsulation area is bounded at a radially outer edge by an inside of a casing of the rotor body or by components which are directly thermally connected to the casing of the rotor body, and in an axial direction by a cover plate and a bottom plate oriented essentially perpendicular to an axis of the rotor body, said field circuit comprising at least one board with electrical components and contacts arranged at an edge of the at least one board, the encapsulation apparatus comprising:
a holder securing the field circuit in the encapsulation area such that the contacts are arranged in a tolerance area around a cylindrical casing surface oriented coaxially with respect to the rotor body,
a toroidal elastic ring pressing against contact surfaces of the contacts having a surface normal oriented substantially parallel to the axis of the rotor body and against the cover plate and the bottom plate for liquid-tight closure of the encapsulation area, such that all contact surfaces located in the tolerance area are at least partially in contact with the toroidal elastic ring.

31. The apparatus of claim 30, wherein the holder extends along a circumferential direction on a radially inner face of the rotor body, wherein the holder comprises recesses or flattened areas located on a radially inner face of the holder for positive locking of electrical components, and wherein a radially outer face of the holder is matched to a shape of the radially inner face of the rotor body.

32. The apparatus of claim 31, wherein the electrical components are power semiconductors.

33. The apparatus of claim 31, wherein the electrical components comprise heat transfer surfaces in large-area thermal contact with the recesses or flattened areas, wherein the recesses or flattened areas have surface normals aligned substantially in a radial direction.

34. The apparatus of claim 31, wherein the electrical components fastened to the holder with screws.

35. The apparatus of claim 31, wherein the electrical components are connected to the holder by brackets.

36. The apparatus of claim 31, wherein the holder is composed of material having a high thermal conductivity.

37. The apparatus of claim 31, wherein the holder is composed of copper.

38. The apparatus of claim 31, wherein the holder is connected with a positive fit to the radially inner face of the rotor body.

39. The apparatus of claim 38, wherein the holder is composed of at least one material selected from the group consisting of fiber-reinforced plastic, glass-fiber-reinforced plastic, carbon-fiber-reinforced plastic and aramid-fiber-reinforced plastic.

40. The apparatus of claim 30, wherein the toroidal elastic ring is composed predominantly of silicone.

41. The apparatus of claim 30, wherein the contacts are composed of copper.

42. The apparatus of claim 30, further comprising at least one displacement body which is matched to a shape of the board and to a shape of the components disposed on the board.

43. The apparatus of claim 42, wherein the at least one displacement body is composed predominantly of glass-fiber-reinforced plastic.
